(19) United States
(12) Patent Application Publication
(10) Pub. No.: US 2015/0348164 A1
(43) Pub. Date: Dec. 3, 2015

(54) METHOD AND SYSTEM FOR MUSIC RECOMMENDATION

(71) Applicant: Uma Satish Doshi, Portland, OR (US)

(72) Inventor: Uma Satish Doshi, Portland, OR (US)

(21) Appl. No.: 14/508,253

(22) Filed: Oct. 7, 2014

Related U.S. Application Data
(60) Provisional application No. 61/995,148, filed on Apr. 3, 2014.

(51) Int. Cl. G06Q 30/06; G10L 25/48; G10L 25/03

(52) U.S. Cl. CPC G06Q 30/0631; G10L 25/03; G10L 25/48

(57) ABSTRACT

A music recommendation system. Signals representing particular works of authorship are transformed into the frequency domain and further manipulated to produce “signatures” for the works, and the similarities of the signatures can be used as a basis for recommending to a person who is known to enjoy, or known to have purchased, one work of authorship one or more other works of authorship the person may also enjoy or seek to purchase.

### RELATED APPLICATIONS

The present application claims the benefit of U.S. provisional application Ser. No. 61/995,148, the disclosure of which is incorporated by reference herein in its entirety.

### FIELD OF THE INVENTION

The present invention relates to a method and system for discerning similarities in musical works of authorship, for use in recommending to a person who enjoys one musical work one or more other musical works the person may also enjoy.

### BACKGROUND

Musical works of authorship have long been recognized as being potentially similar if they originated from, or were performed by, the same artist. “Genre” is also used as a standard basis for recognizing potential similarity in musical works, so a number of classifications have been developed, such as “hard rock” or “country western.”

These traditional approaches to music recommendation are important but limited in scope, and there is active research into more comprehensive and analytical methods for categorizing or classifying musical works for the purpose of making recommendations.

To date however, the problem of providing reliable music recommendations has not been solved, and there is a need for a novel method and system for music recommendation that is simple yet powerful.

### SUMMARY

A music recommendation system is disclosed herein. A computer system is provided with a first signal f₁(t) that is a time varying amplitude representation of a first work of authorship and a second signal f₂(t) that is a time varying amplitude representation of a second work of authorship, and is programmed to perform a method that includes the following steps: performing respective frequency transformations of the signals f₁(t) and f₂(t), thereby obtaining respective first and second frequency varying functions F₁(ω) and F₂(ω); deriving first and second magnitude functions M₁(ω) and M₂(ω) from, respectively, the functions F₁(ω) and F₂(ω), the magnitude functions being based on the magnitudes of the functions F₁(ω) and F₂(ω); fitting to the magnitude functions respective first and second calming functions C₁(ω) and C₂(ω), each calming function imposing on its respective magnitude function a limited number “n” of inflection points by use of a sum of terms defining respective coefficients multiplying distinct powers of the variable (ω) that are the same in both the first and second calming functions; computing modified first and second calming functions MC₁(ω) and MC₂(ω) from the respective calming functions C₁(ω) and C₂(ω) so as to more nearly equalize the orders of magnitude of the coefficients of the terms of the first and second calming functions that multiply the non-zero powers of( ); comparing the modified calming functions C₁(ω) and MC₂(ω) including computing one or more measures of difference therebetween; and wherein, if the one or more measures of difference is within one or more predetermined limits but not if otherwise, producing an output predetermined to indicate that a person who enjoys the first work may enjoy the second work, thereby providing at least a partial basis for making a recommendation.

The works of authorship may be or include, but are not necessarily limited to aurally perceived works.

Advantageously in the case where the works of authorship are musical works, the computer may be programmed to perform the step of deriving so that the magnitude functions are based on the magnitudes of the functions F₁(ω) and F₂(ω) squared.

The computer may be further programmed to factor each of the coefficients of the terms of the first and second calming functions into two respective parts A and B where each of the parts A is a number greater than or equal to 1 and less than a base selected to be the same for all the coefficients of the first and second calming functions, and each of the parts B is a number equal to the base raised to a respective power, and, where there are “n” coefficients in each calming function for non-zero powers of (ω), to perform the step of computing the modified first and second calming functions so as to include dividing each of the “n” coefficients by the respective parts B.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF DRAWINGS

FIG. 1 is block diagram of a computer system for providing music recommendations according to the present invention.

FIG. 2 is a flow chart of steps which the computer system of FIG. 1 is programmed to perform according to the present invention.

FIGS. 3-6 are plots of music signatures achieved by performance of the steps charted in FIG. 2 for various artists, in arbitrary units of magnitude (ordinate) and frequency (abscissa).

FIG. 7 is a plot comparing a number of different music signatures achieved by performance of the steps charted in FIG. 2 for various artists and types of music, in arbitrary units of magnitude (ordinate) and frequency (abscissa).

### DETAILED DESCRIPTION OF PREFERRED EMBODIMENTS

The present invention provides generally for discerning similarities in works of authorship, for use in recommending to a person who is known to enjoy, or known to have purchased, one work of authorship one or more other works of authorship the person may also enjoy or seek to purchase. A preferred context for the invention is for use in music recommendation, and the invention will be primarily described in that context, but it should be understood that invention is not limited to use in music recommendation.

The term “work of authorship,” or simply “work,” refers to the categories of copyright eligible subject matter defined in 35 U.S.C. §102(a). Works of authorship are distinct from the “useful” arts that are the subject matter of patents, and are often utilized for entertainment. For purposes herein, it is not necessary that a work have a human author.

The term “music” encompasses those categories of works of authorship known as sound recordings and musical works, as well as the music accompanying a dramatic work or a motion picture or other audiovisual work.

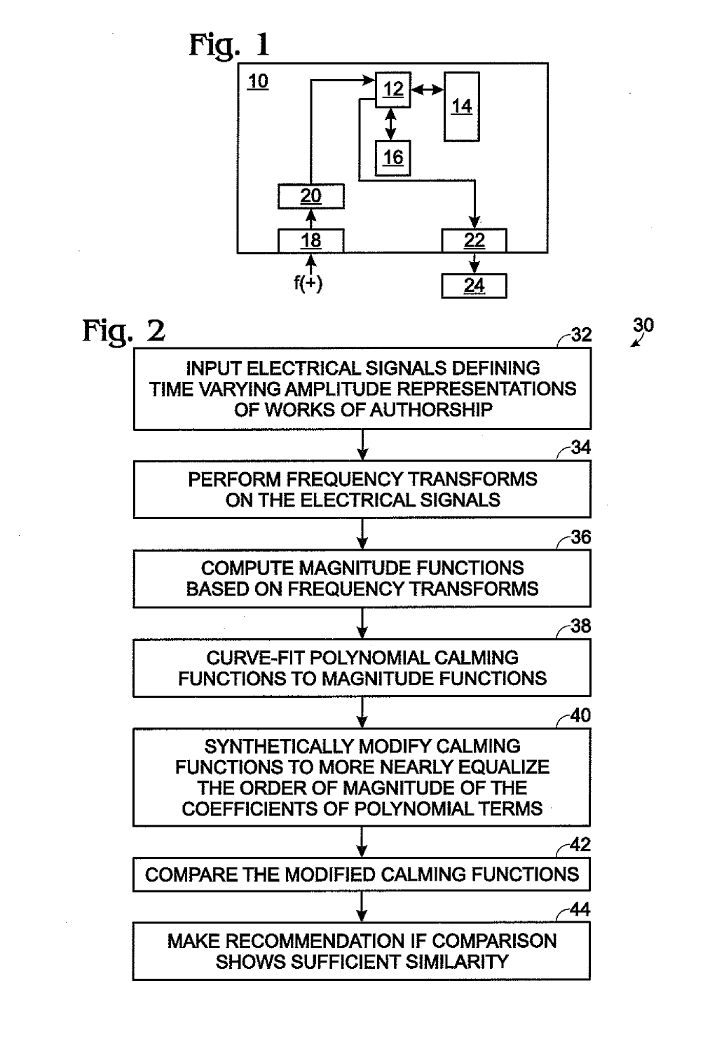

FIG. 1 shows a music recommendation system 10, which is a computer system programmed specifically to perform a number of steps of a method that is useful for the afore-stated purpose. The computer system 10 may employ any number of individual computers connected to each other as desired, such as through a local area network (LAN) or a wide area network (WAN) such as the Internet. But the system 10 may advantageously employ just one computer which may be a standard PC or Mac. Somewhere in the system 10 there is a processing unit 12, a storage memory 14 for storing data and data processing instructions, a working memory 16 which may be part of the storage memory for performing the stored data processing instructions on the stored data, a data input bus 18 for receiving the data, an analog to digital converter 20 for transforming the data to digital form if the data are not already being presented in digital form, and a data output bus 22 for outputting data processed by the system.

From the data output bus 22, the data may be transmitted to another computer system, or to a data rendering device 24 such as a display screen or printer for rendering the data so that the data can be visually perceived.

The computer system 10 can be programmed by a person of ordinary skill in the computer programming arts to perform the functions described herein.

The system 10 takes as input signals that are representative of the works of authorship under consideration. Typically, the signals will be electrical signals, but they could be optical signals or any other type of signal the computer system 10 is capable of processing. The signals can also be in either digital or analog form.

Playing a sound recording, or motion picture or other audiovisual work, or performing a musical work or dramatic work, produces sound waves. The sound waves may be transformed into an electrical signal by use of a microphone. The sound waves could also be transformed into any other type of signal that the computer system 10 is capable of processing.

Music is, however, generally originally fixed in a visually perceptible form, such as sheet music. In such form it may be translated into representative signals that can be processed by the computer system 10 without the need to create or reproduce any sounds.

In either case, works of music will be referred to generally hereinafter as aurally perceived works because that is how such works are typically enjoyed.

A signal has a time-varying amplitude f(t). For comparing two works, two such signals will be required, which may be referred to as f₁(t) and f₂(t). The signals will ordinarily be digitized for processing within the computer system 10.

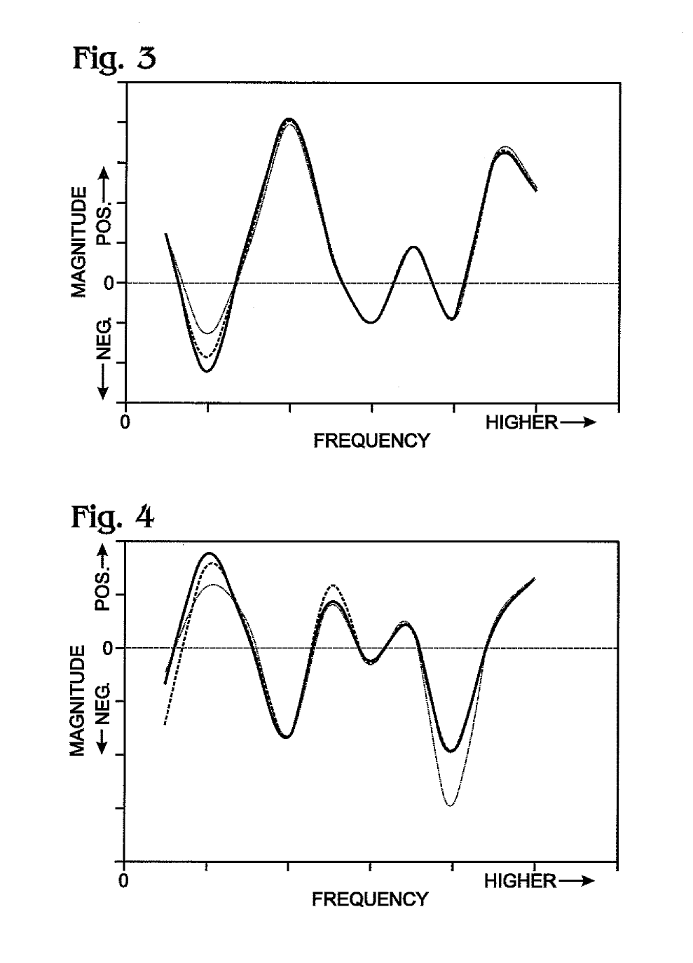

FIG. 2 shows how the computer system 10 may process the signals f₁(t) and f₂(t), by performing the following steps of a music recommendation method 30.

In a step 32, the signals f₁(t) and f₂(t) are provided to the computer system 10.

In a step 34, a “frequency transform” is performed on each of the signals f₁(t) and f₁(t).

There are a number of different frequency transforms that could be used. The Fourier series and the Fourier transform are probably the two such transforms that are the most famous, but there are also the discrete Fourier transform, the Fast Fourier transform, the LaPlace transform, the short-time Fourier transform, the cosine transform, and the wavelet transform, to name a few.

In general, a frequency transform of a function f(a), where the variable “a” could be either a time variable “t” or one or more spatial variables “x,” “y,” and “z,” will be defined broadly for purposes herein to comprise the sum Σ(ω) of a series of orthonormal basis functions of varying frequencies (ω) multiplied by respective coefficients, where the coefficients are computed so as to minimize the mean-square error between f(a) and Σ(ω). It may be noted that this definition allows for the sum of the series becoming an integral in the limit where the difference in the frequencies of the respective basis functions goes to zero.

The orthonormal basis functions may be, more specifically, periodically varying in (ω) such as in the Fourier transform, with which good results have been obtained using the software marketed as MATLAB® by the MathWorks corporation, headquartered in Natick, Mass.

The output of the transforming function step 30 is two functions F₁(ω), F₂(ω), corresponding respectively to f₁(t), f₂(t).

Next, in a step 36, magnitude functions M₁(ω) and M₂(ω) are computed, respectively, from the transform functions F₁(ω) and F₂(ω). The magnitude functions are “based on” the magnitudes of the transform functions, meaning that each magnitude function is derived, at least in part, from the magnitude of the respective transform function. For example, a magnitude function 1+|ω| is based on the magnitude of (ω). However, the magnitude functions are preferably simply proportional to the magnitudes of the respective transform functions.

In the general case where a transform function F(ω) may have either or both real and imaginary parts, the magnitude of F(ω) is [Re(F(ω))²+Im(F(ω))²]^{1/2}.

In the case of aurally perceived works, it is important that ears are sensitive to the power represented in the signals f(t), so in such cases the magnitude functions are preferably based on the magnitudes of the transform function by squaring the magnitudes of the transform functions.

Next, in a step 38, calming functions C₁(ω) and C₂(ω) are computed, respectively, from the magnitude functions M₁(ω) and M₂(ω) by curve-fitting. Particularly, each calming function C(ω) includes a sum of terms of varying powers of the variable (ω):

C₀ω⁰+C₁ω¹+C₂ω²+C₃ω³ . . . +Cₙωⁿ

The purpose of the calming functions C(ω) is to impose, on the respective magnitude functions, a limited number “n” of inflection points, where the number, location, and/or magnitude of the inflection points define a “signature” of the sound recordings represented by the calming functions. The C₀ω⁰ term may be ignored for purposes of discerning inflection behavior, so the essential terms of the calming function for purposes of signature analysis are:

C₁ω¹+C₂ω²+C₃ω³ . . . +Cₙωⁿ

It has been found that for sound recordings, good results may be obtained with “n”=6, with somewhat better results with “n”=9, with still higher values of “n” providing for rapidly diminishing returns. Preferably, “n” is at least four, and more preferably it is at least five, and is less than 12.

Each calming function has a term of the same order of magnitude of (t), so each term of one of the calming functions C₁(ω), C₂(ω) corresponds to a unique one of the terms of the other of the calming functions C₂(ω), C₁(ω),

While integral exponents are preferably used to define the powers of (ω) in the terms of the calming functions, this is not essential, e.g., the exponents 1, 2, 3, . . . etc. could be 1.1, 2.1, 3.1, . . . etc.

Also while evenly spaced exponents such as 1, 2, 3, . . . etc. or 1.1, 2.1, 3.1, . . . etc. are preferably used to define the powers of (ω) in the terms of the calming functions, this is not essential; the exponents could be unevenly spaced, such as 1.1, 2.3, 4.2, . . . etc.

Next, in a step 40, the calming functions C(ω) are synthetically modified to more nearly equalize the orders of magnitude of the coefficients C of non-zero powers of (ω), i.e. the coefficients C₁, C₂, C₃, . . . Cₙ.

Preferably, the coefficients Cₙ are modified to have the same order of magnitude. This may be ensured by factoring each of them into two respective parts A and B, where parts A will all be numbers greater than or equal to 1 and less than a base (or radix) that is the same for all the coefficients, and parts B will be the base raised to various powers, and dividing each coefficient by its respective part B.

For example, considering the term C₂ω², suppose C₂=1.8·10⁻⁵, the base in this example being ten. Then part A for the coefficient C₂ equals 1.8 and part B for the coefficient C₂ equals the base ten raised to the power −5, and the coefficient C₂ is modified by dividing it by 10⁻⁵ to make it equal to 1.8. That is, C₂=1.8·10 is modified to become just 1.8, i.e., the coefficient of the coefficient.

The calming functions as modified in step 40 may be referred to as modified calming functions MC(ω). Summarizing, the modified calming functions maintain the differences between terms specified by the coefficients of the coefficients, while at least decreasing, and preferably eliminating entirely, differences in the orders of magnitude of the coefficients.

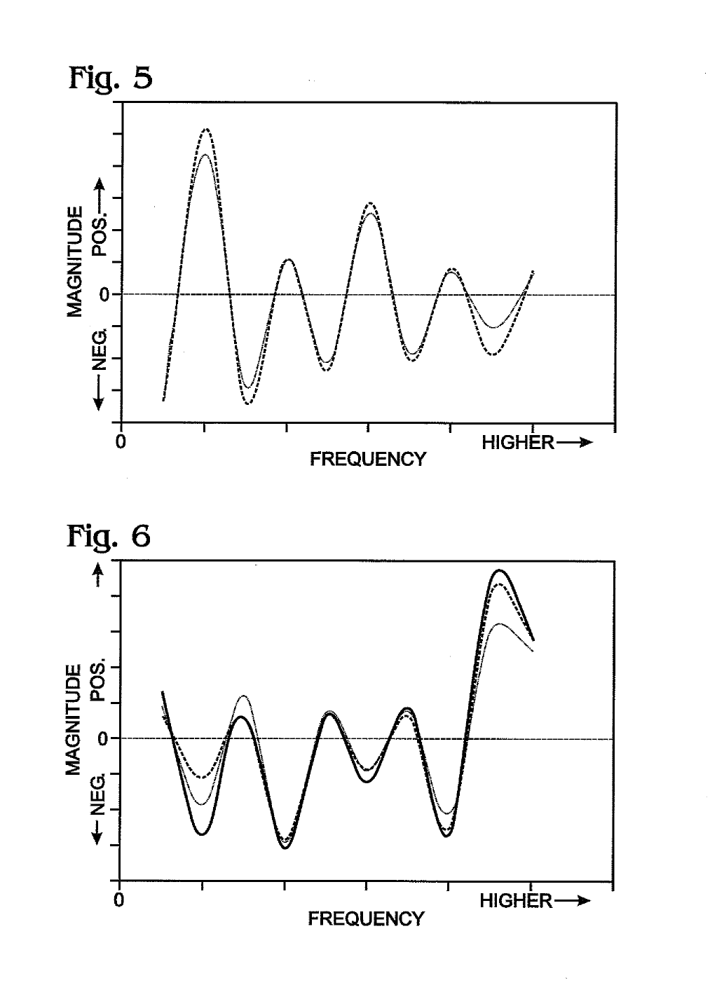

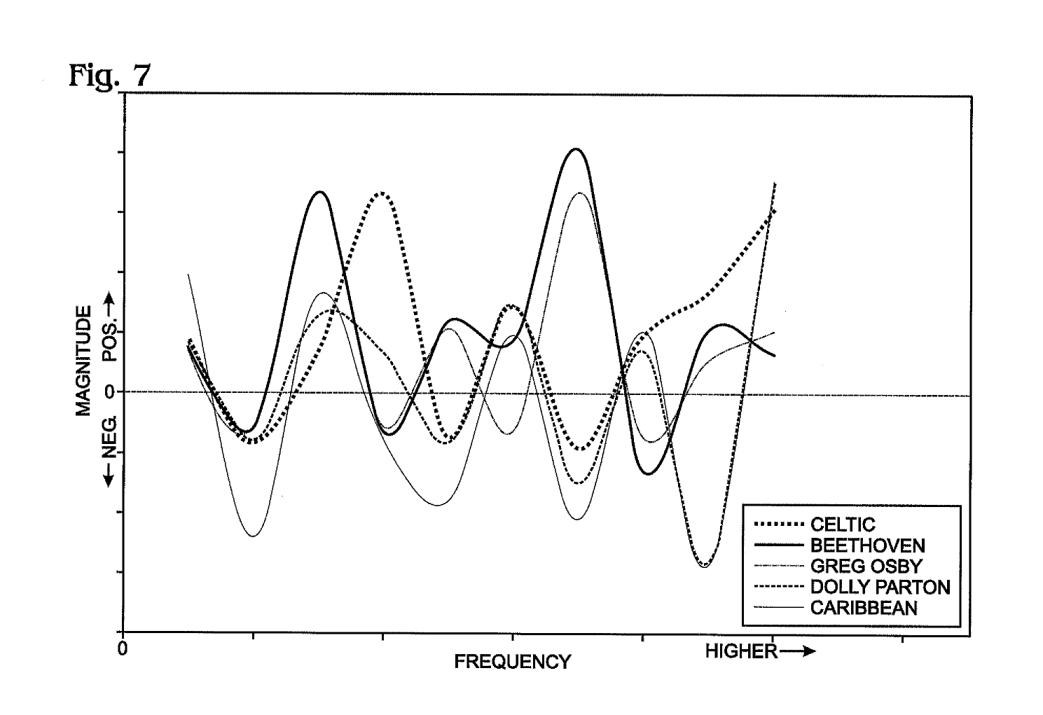

The modified calming functions MC(ω) are recognized according to the invention as “signatures” of the works represented by the original signals f(t). FIGS. 3-7 show such signatures achieved by use of the method 30 for aurally perceived works, more particularly sound recordings, using Fourier transforms in step 34, squaring the magnitudes in step 36, and fully equalizing the orders of magnitude of the coefficients of the calming functions in step 40. It may be observed in FIGS. 3-7 that the signatures for different sound recordings by the same artist differ only slightly, whereas the signatures for different artists differ greatly, and so it appears that the method 30 provides a simple yet powerful means of discerning similarities in sound recordings that are likely to be important for judging a listener's musical preferences.

Returning to FIG. 2, the method 30 includes a step 42 of comparing the modified calming functions C₁(ω) and MC₂(ω). It may be sufficient to visually compare signatures when the similarities and differences are as readily apparent as in FIGS. 3-7, but for analysis by the computer system 10, the signatures are compared analytically for whether they fall within acceptable limits. This can be done using any of a number of known mathematical techniques, as desired. For example, the computer system 10 may be programmed to specify limits on the frequency separation between corresponding inflection points of the modified calming functions, alone or in combination with specifying limits on the area between the two modified calming functions near the inflection points.

For a discussion of various such techniques, see Mario Mongiardini et al., “Development of Software for the Comparison of Curves During the Verification and Validation of Numerical Models,” 7^{th} European LS-DYNA Conference, which at the time of this writing can be found at www.dynamore.de/en/downloads/papers/09-conference/papers/K-I-03.pdf, the document being incorporated by reference herein in its entirety.

If the difference between two signatures is within acceptable limits, the signatures can be considered close enough for recommending that a person who enjoys the work associated with one of the signatures may also enjoy the work associated with the other signature. Thus in a step 44 of the method 30, the computer system 10 will produce an appropriate useful output, such as to send a recommendation, or to initiate consideration of other factors relevant to deciding whether to make a recommendation. For example, if a person purchases a copy of the first work, the entity responsible for the sale, or some other entity which learns of the sale, can recommend to the person to consider purchasing a copy of the second work as well, or consider making such a recommendation after further taking into account other purchasing history associated with the person.

The method 30 has distinct advantages, over recommending works on the basis that the same artist is responsible for them, or because they are of the same genre, of being applicable in cases where the artist is not the same, or the genre is different, but the work is nevertheless similar.

The method 30 may be combined with other methods for discerning similarities between works as desired. The method 30 may also be carried out separately on selected, limited (time) duration portions of a work, and/or on selected, limited (frequency) width portions.

The method 30 may also be generalized to make recommendations concerning works other than aurally perceived works such as sound recordings and musical works. For example, the method could be used for discerning and comparing signatures of visually perceived works such as pictorial, graphic, or sculptural works. Analogous to representing sound recordings by signals f(t) that specify the time-varying amplitude of sound waves associated with the sound recordings, such visually perceived works may be represented by signals specifying the spatially-varying amplitude and color of light waves associated with the works, e.g., A(x, y, z) (light intensity or amplitude), R(x, y, z), G(x, y, z), and B(x, y, z), where R, G, and B are color components of the signal.

Accordingly, even though f(t) is necessarily a time-varying signal, it can be used to represent variations in space, in which case the frequency transform is a “spatial” frequency transform rather than a “temporal” frequency transform, with (ω) serving as a variable of spatial rather than temporal frequency for functions f(t) that represent spatial variations, such as variations in the amplitude and/or color of light associated with a spatially distributed work. With that understanding, any of these spatial functions may be processed according to the method 30 to achieve signatures that may be useful for discerning a viewer's preference for visually perceived works, just like the signatures for aurally perceived works.

It is to be further understood that, while a specific music recommendation system has been shown and described as preferred, variations may be employed without departing from the principles of the invention, and that the scope of the invention is defined and limited only by the claims which follow.

1. A system for recommending works of authorship by recognizing similarities therebetween, comprising providing to a computer system a first signal f₁(t) that is a time varying amplitude representation of a first work of authorship and a second signal f₂(t) that is a time varying amplitude representation of a second work of authorship, the computer system being programmed to perform a method comprising the steps of:
performing respective frequency transformations of the signals f₁(t) and f₂(t), thereby obtaining respective first and second frequency varying functions F₁(ω) and F₂(ω);
deriving first and second magnitude functions M₁(ω) and M₂(ω) from, respectively, the functions F₁(ω) and F₂(ω), the magnitude functions being based on the magnitudes of the functions F₁(ω) and F₂(ω);
fitting to the magnitude functions respective first and second calming functions C₁(ω) and C₂(ω), each calming function imposing on its respective magnitude function a limited number “n” of inflection points by use of a sum of terms defining respective coefficients multiplying distinct powers of the variable (ω) that are the same in both the first and second calming functions;
computing modified first and second calming functions MC₁(ω) and MC₂(ω) from the respective calming functions C₁(ω) and C₂(ω) so as to more nearly equalize the orders of magnitude of the coefficients of the terms of the first and second calming functions that multiply the non-zero powers of (ω);
comparing the modified calming functions MC₁(ω) and MC₂(ω) including computing one or more measures of difference therebetween; and
wherein, if said one or more measures of difference is within acceptable limits but not if otherwise, producing an output predetermined to indicate that a person who enjoys the first work is likely to enjoy the second work, thereby providing at least a partial basis for making a recommendation.

2. The system of claim 1, wherein the first and second works of authorship are aurally perceived works, and wherein (ω) is a variable of temporal frequency.

3. The system of claim 2, wherein the computer is further programmed to perform said step of deriving so that the magnitude functions are based on the magnitudes of the functions F₁(ω) and F₂(ω) squared.

4. The system of claim 1, wherein the computer is further programmed to perform said step of deriving so that the magnitude functions are based more specifically on the squares of the magnitudes of the functions F₁(ω) and F₂(ω).

5. The system of claim 4, wherein the computer is further programmed to factor each of the coefficients of the terms of the first and second calming functions into two respective parts A and B where each of the parts A is a number greater than or equal to 1 and less than a base selected to be the same for all the coefficients of the first and second calming functions, and each of the parts B is a number equal to the base raised to a respective power, and, where there are “n” coefficients in each calming function for non-zero powers of (ω), to perform said step of computing the modified first and second calming functions so as to include dividing each of the “n” coefficients by the respective parts B.

6. The system of claim 3, wherein the computer is further programmed to factor each of the coefficients of the terms of the first and second calming functions into two respective parts A and B where each of the parts A is a number greater than or equal to 1 and less than a base selected to be the same for all the coefficients of the first and second calming functions, and each of the parts B is a number equal to the base raised to a respective power, and, where there are “n” coefficients in each calming function for non-zero powers of (ω), to perform said step of computing the modified first and second calming functions so as to include dividing each of the “n” coefficients by the respective parts B.

7. The system of claim 2, wherein the computer is further programmed to factor each of the coefficients of the terms of the first and second calming functions into two respective parts A and B where each of the parts A is a number greater than or equal to 1 and less than a base selected to be the same for all the coefficients of the first and second calming functions, and each of the parts B is a number equal to the base raised to a respective power, and, where there are “n” coefficients in each calming function for non-zero powers of (ω), to perform said step of computing the modified first and second calming functions so as to include dividing each of the “n” coefficients by the respective parts B.

8. The system of claim 1, wherein the computer is further programmed to factor each of the coefficients of the terms of the first and second calming functions into two respective parts A and B where each of the parts A is a number greater than or equal to 1 and less than a base selected to be the same for all the coefficients of the first and second calming functions, and each of the parts B is a number equal to the base raised to a respective power, and, where there are “n” coefficients in each calming function for non-zero powers of (ω), to perform said step of computing the modified first and second calming functions so as to include dividing each of the “n” coefficients by the respective parts B.
